(19) United States
(12) Patent Application Publication
(10) Pub. No.: US 2024/0227085 A1
(43) Pub. Date: Jul. 11, 2024

(54) SEMICONDUCTOR WAFER LASER CUTTER LENS PLATE HOLDER

(71) Applicant: Skyworks Solutions, Inc., Irvine, CA (US)

(72) Inventors: Aristeo Lanon Realica, Newbury Park, CA (US); Armando Valadez Anguiano, Mexicali (MX); Jose Luis De La Torre Marquez, Mexicali (MX)

(21) Appl. No.: 18/538,442

(22) Filed: Dec. 13, 2023

Related U.S. Application Data
(60) Provisional application No. 63/438,192, filed on Jan. 10, 2023.

(51) Int. Cl. B23K 26/70; B23K 26/00; B23K 26/06

(52) U.S. Cl. CPC B23K 26/706; B23K 26/0006; B23K 26/0648; B23K 2101/40

(57) ABSTRACT

A semiconductor wafer laser cutting lens plate holder comprising a first engagement portion and a second engagement portion. The first engagement portion opposes the second engagement portion such that they are configured to hold a lens plate by way of slidably engaging the lens plate with the first engagement portion and the second engagement portion.

### INCORPORATION BY REFERENCE TO PRIORITY APPLICATIONS

Any and all applications for which a foreign or domestic priority claim is identified in the Application Data Sheet as filed with the present application, or any correction thereto, including U.S. Provisional Patent Application No. 63/438,192, filed on Jan. 10, 2023, titled “SEMICONDUCTOR WAFER LASER CUTTER LENS PLATE HOLDER,” the entirety of which are hereby incorporated by reference under 37 CFR 1.57.

### BACKGROUND

### Field

Embodiments of the invention relate to the field of systems and methods for the laser cutting of semiconductor wafers.

### Description of the Related Technology

The manufacture of integrated circuit dies involves separating dies from a wafer of semiconductor following the processing of the wafer. One way of separating dies from the wafer is laser cutting the wafer.

### SUMMARY

According to one embodiment there is provided, a semiconductor wafer laser cutter lens plate holder, comprising: a first engagement portion; a second engagement portion; and the first engagement portion opposing the second engagement portion such that they are configured to hold a lens plate by way of slidably engaging the lens plate with the first engagement portion and the second engagement portion.

In one example the lens plate holder may further comprise a surface configured to support the lens plate. In another example the first engagement portion and the second engagement portion may project from the surface. In yet another example, the first engagement portion may be configured to engage a first edge of the lens plate and the second engagement portion may be configured to engage a second edge of the lens plate.

In one example the lens plate holder may further comprise a third engagement portion. In a further example the third engagement portion may be positioned adjacent to a first end of the first engagement portion and a first end of the second engagement portion. In yet a further example, the third engagement portion may be configured to hold the lens plate by way of slidably engaging the lens plate with the third engagement portion. In another example, the third engagement portion may be configured to engage a third edge of the lens plate.

In one example the lens plate holder may further comprise a fixing mechanism configured to fix in position a first edge of the lens plate in the first engagement portion, a second edge of the lens plate in the second engagement portion and a third edge of the lens plate in the third engagement portion. In another example the fixing mechanism may have a raised portion projecting from a surface configured to support the lens plate. In yet another example, the fixing mechanism may be positioned adjacent to a second end of the first engagement portion and a second end of the second engagement portion. In a further example, the fixing mechanism may oppose the third engagement portion. In yet a further example, the fixing mechanism may be configured to form a barrier at a fourth edge of the lens plate.

In one example, the surface may have an opening corresponding to the shape of a protective lens. In another example, a height of the first engagement portion and a height of the second engagement portion may correspond to a thickness of the lens plate. In yet another example, the height of the first engagement portion and a height of the second engagement portion may be between 0.5 millimeters and 1.5 millimeters. In a further example, a width of the first engagement portion and a width of the second engagement portion may be between 1 millimeter and 3.5 millimeters. In yet a further example, the opening may not be obstructed by the first engagement portion and the second engagement portion.

In one example a length of the first engagement portion may be configured to extend along a portion of the first edge of the lens plate, a length of the second engagement portion may be configured to extend along a portion of the second edge of the lens plate, and a length of the third engagement portion may be configured to extend along a portion of the third edge of the lens plate.

In another example, the length of the first engagement portion and the length of the second engagement portion may be smaller than the length of the third engagement portion. In yet another example, the length of the first engagement portion and the length of the second engagement portion may be between 15 millimeters and 30 millimeters. In a further example, the length of the third engagement portion may be between 30 millimeters and 45 millimeters.

According to another embodiment there is provided, a semiconductor wafer laser cutting system, comprising: a laser configured to emit a laser beam; an amplifying lens configured to amplify the laser beam to cut a semiconductor wafer; a lens plate configured to retain a protective lens, the protective lens being configured to protect the amplifying lens; and a lens plate holder having a first engagement portion and a second engagement portion, the first engagement portion opposing the second engagement portion such that they are configured to hold the lens plate by way of slidably engaging the lens plate with the first engagement portion and the second engagement portion.

In one example the lens plate may be flexible. In another example, the protective lens may be configured to protect the amplifying lens from fumes produced by cutting the semiconductor wafer. In yet another example, the lens plate holder may be configured to hold the lens plate in such a position that the lens plate does not obstruct a path of the laser beam.

According to another embodiment there is provided, a method of assembling a semiconductor wafer laser cutting system, comprising: slidably engaging a lens plate with a first engagement portion and a second engagement portion of a lens plate holder, the first engagement portion opposing the second engagement portion; and holding the lens plate by way of the first engagement portion and the second engagement portion.

In one example the method may further comprise slidably engaging the lens plate with a third engagement portion of the lens plate holder, the third engagement portion positioned adjacent to a first end of the first engagement portion and a first end of the second engagement portion.

In another example the method may further comprise fixing the lens plate into a position in which a first edge of the lens plate is engaged with the first engagement portion, a second edge of the lens plate is engaged with the second engagement portion and a third edge of the lens plate is engaged with the third engagement portion.

In yet another example fixing the lens plate may include positioning a fourth edge of the lens plate adjacent to a fixing mechanism of the lens plate holder, the fixing mechanism opposing the third engagement portion. In a further example, the method may further comprise supporting the lens plate on a surface of the lens plate holder. In yet a further example, the method may further comprise flexing the lens plate to fix the lens plate into the position.

In one embodiment, a lens plate holder for a semiconductor wafer laser cutter, the lens plate holder comprising a first engagement portion opposing a second engagement portion, the first engagement portion and the second engagement portion slidably engage a lens plate.

In other embodiments, a surface is configured to support the lens plate and the first engagement portion and the second engagement portion project from the surface. In yet other embodiments, the surface has an opening corresponding to a shape of a protective lens. In further embodiments, the first engagement portion engages a first edge of the lens plate and the second engagement portion engages a second edge of the lens plate.

In additional embodiments, the lens plate holder further comprises a third engagement portion. In other embodiments, the third engagement portion is positioned adjacent to a first end of the first engagement portion and a first end of the second engagement portion. In yet other embodiments, the third engagement portion slidably engages the lens plate. In further embodiments, the third engagement portion engages a third edge of the lens plate. In yet further embodiments, a length of the first engagement portion extends along a portion of a first edge of the lens plate, a length of the second engagement portion extends along a portion of a second edge of the lens plate, and a length of the third engagement portion extends along a portion of a third edge of the lens plate.

In certain embodiments, the lens plate holder further comprises a fixing mechanism that positions a first edge of the lens plate in the first engagement portion, a second edge of the lens plate in the second engagement portion and a third edge of the lens plate in the third engagement portion. In other embodiments, the fixing mechanism has a raised portion projecting from a surface that supports the lens plate. In yet other embodiments, the fixing mechanism is positioned adjacent to a second end of the first engagement portion and a second end of the second engagement portion.

In one or more embodiments, a semiconductor wafer laser cutting system comprises a laser that emits a laser beam; an amplifying lens that amplifies the laser beam to cut a semiconductor wafer; a lens that retains a protective lens that protects the amplifying lens; and a lens plate holder having a first engagement portion opposing a second engagement portion, the first engagement portion and the second engagement portion slidably engage the lens plate.

In other embodiments, the lens plate is flexible. In yet other embodiments, the protective lens protects the amplifying lens from fumes produced by cutting the semiconductor wafer. In yet other embodiments, the lens plate holder holds the lens plate in such a position that the lens plate does not obstruct a path of the laser beam.

In additional embodiments, a method of assembling a semiconductor wafer laser cutting system comprises slidably engaging a lens plate with a first engagement portion and a second engagement portion of a lens plate holder, the first engagement portion opposing the second engagement portion; and holding the lens plate by way of the first engagement portion and the second engagement portion.

In other embodiments, the method comprises slidably engaging the lens plate with a third engagement portion of the lens plate holder, the third engagement portion positioned adjacent to a first end of the first engagement portion and a first end of the second engagement portion. In yet other embodiments, the method comprises fixing the lens plate into a position by engaging a first edge with the first engagement portion, engaging a second edge of the lens plate with the second engagement portion and engaging a third edge of the lens plate with the third engagement portion. In further embodiments, fixing the lens plate includes positioning a fourth edge of the lens plate adjacent to a fixing mechanism of the lens plate holder, the fixing mechanism opposing the third engagement portion.

Still other aspects, embodiments, and advantages of these exemplary aspects and embodiments are discussed in detail below. Embodiments disclosed herein may be combined with other embodiments in any manner consistent with at least one of the principles disclosed herein, and references to “an embodiment,” “an another embodiment,” “additional embodiments,” some embodiments,” “an alternate embodiment,” “various embodiments,” “one embodiment,” “other embodiments,” “further embodiments,” or the like are not necessarily mutually exclusive and are intended to indicate that a particular feature, structure, or characteristic described may be included in at least one embodiment. The appearances of such terms herein are not necessarily all referring to the same embodiment.

Also, for purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. In the figures, each identical or nearly identical component that is illustrated in various figures is represented by a like numeral. For purposes of clarity, not every component may be labeled in every figure. In the figures:

FIGS. 1A and 1B are schematic diagrams of example known laser cutting systems.

FIGS. 2A and 2B are schematic diagrams of example dies resulting from a laser cutting process.

FIG. 3 is a schematic diagram of a known DISCO Corporation of Japan model DFL7160 laser cutting machine.

FIG. 4 is a schematic diagram of an example known lens plate in a known lens plate holder.

FIG. 5 is a schematic diagram showing a section of the laser cutting machine of FIG. 3.

FIG. 6 is a schematic diagram of the lens plate and lens plate holder of FIG. 4.

FIG. 7 is a schematic diagram of an example semiconductor wafer that is the result of a disrupted laser cutting process.

FIG. 8 is a schematic diagram of an example lens plate holder according to one or more embodiments of the invention.

FIG. 9 is a schematic diagram of a second example lens plate holder according to one or more embodiments of the invention.

FIG. 10 is a top view of the lens plate holder of FIG. 8 according to one or more embodiments of the invention.

FIG. 11 is a side view of the lens plate holder of FIG. 8 according to one or more embodiments of the invention.

FIG. 12 is a side view of the lens plate holder of FIG. 8 according to one or more embodiments of the invention.

FIG. 13 is a section of the side view of FIG. 11 according to one or more embodiments of the invention.

FIG. 14 is a schematic diagram of a known lens plate and the lens plate holder of FIG. 8 according to one or more embodiments of the invention.

FIG. 15 is the lens plate and lens plate holder of FIG. 14 in a section of the laser cutting machine of FIG. 3 according to one or more embodiments of the invention.

FIG. 16 is a cross sectional view of the lens plate and lens plate holder of FIG. 14 according to one or more embodiments of the invention.

### DETAILED DESCRIPTION

Aspects and embodiments described herein are directed to a lens plate holder for a semiconductor wafer laser cutting system, and a method of assembling such a system, the system and method having increased die yield.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

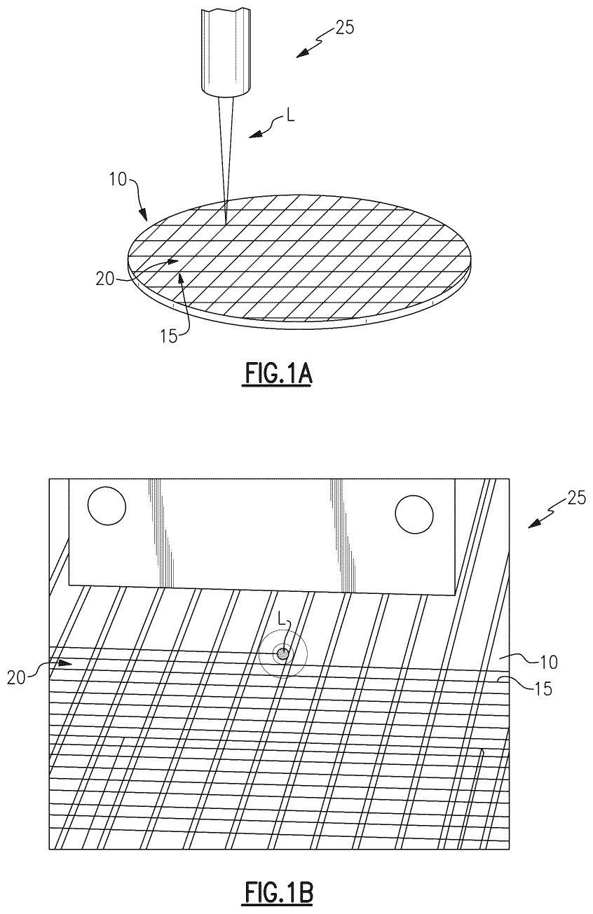

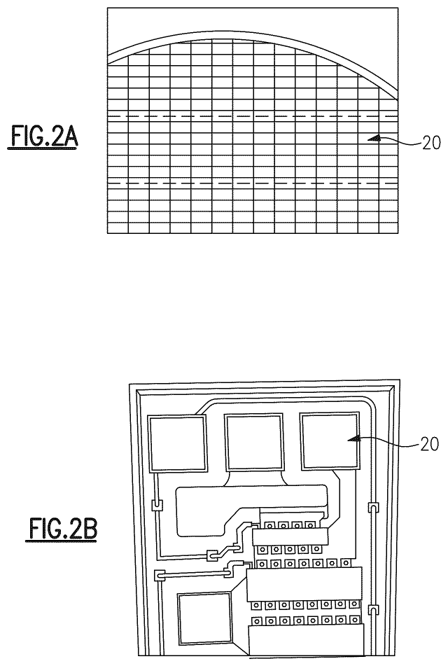

FIGS. 1A and 1B show a semiconductor wafer 10 that can be diced into a plurality of integrated circuit dies 20 along streets 15 (also known as die streets or wafer streets) of the wafer 10. FIGS. 2A and 2B then show the resulting dies 20 from a laser cutting process. One manner of dicing the wafer 10 into the separate integrated circuit dies 20 involves use of a laser cutting machine 25 that directs a laser L at the wafer. Such laser cutting machines 25 include those manufactured by DISCO Corporation of Japan. For example, the model DFL7160 laser cutter 25 shown in FIG. 3.

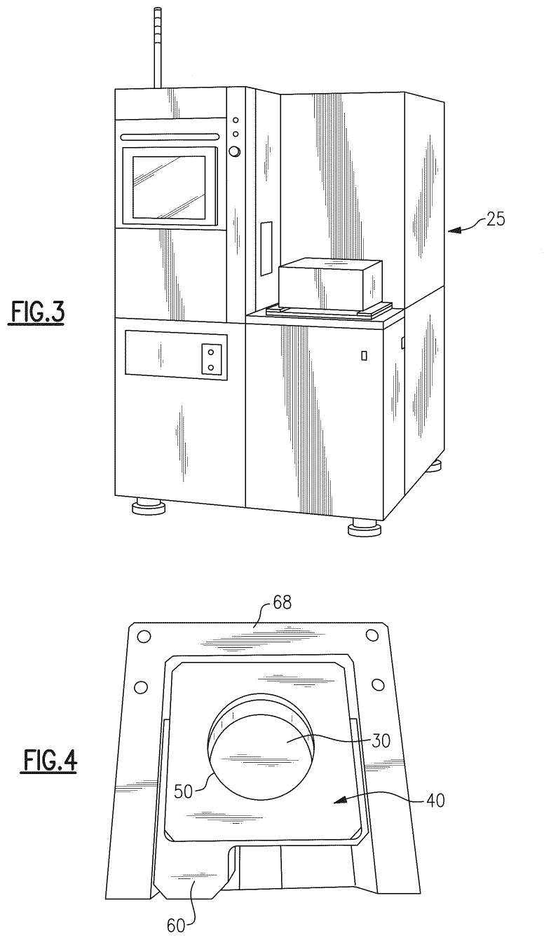

Known laser cutting machines 25, such as those shown in FIGS. 1A, 1B and 3, comprise a laser L. The laser L is configured to emit a laser beam. Such a laser beam is configured to cut a semiconductor wafer 10. Known laser cutting machines 25 further comprise an amplifying lens (not shown). The amplifying lens is configured to amplify the laser beam such that it has sufficient power to cut a semiconductor wafer 10. However, the process of laser cutting semiconductor wafers produces exhaust fumes. These fumes can affect the amplifying lens. This leads to an undesirable loss in laser power. To counteract this problem, the laser cutting machine further comprises a protective lens (see FIG. 4, lens 30). The protective lens 30 is configured to protect (e.g, shield) the amplifying lens from fumes produced during the laser cutting process. To further protect the components of the laser cutting machine 25, vacuum pressure in the machine 25 removes debris resulting from the cutting process. The vacuum acts as an exhaust port to remove dust, debris and exhaust fumes during the cutting process.

An example protective lens 30 is shown in FIG. 4. The lens is retained in a lens plate 40. The lens plate 40 is configured such that it comprises a circular opening 50 through which the lens 30 is exposed. This allows the laser beam for the laser cutting process to propagate through the lens 30. For the laser cutting process, the lens plate 40 is held by a lens plate holder 60. Known lens plate holders 60, such as that shown in FIG. 4, comprise a surface configured to support the lens plate 40 (see FIG. 6, surface 65). The lens plate 40 rests on said surface 65. The surface 65 further comprises an opening (see FIG. 6, opening 67). The opening 67 corresponds to opening 50 of the lens plate 40. Said opening 67, again, allows the laser beam to propagate through the protective lens 30 to a semiconductor wafer when the lens plate 40 is held by the lens plate holder 60. The vacuum pressure in the laser cutting machine 25 holds the lens plate 40 in place on surface 65. However, during a laser cutting process, the vacuum pressure is prone to fluctuations. Such fluctuations can lead to changes in the position of the lens plate 40 on surface 65. This problem is exacerbated if the lens plate 40 was not initially positioned correctly on surface 65. As the protective lens 30 often needs to be removed for cleaning and subsequently repositioned on the lens plate holder 60, there are frequent opportunities for errors in positioning to arise.

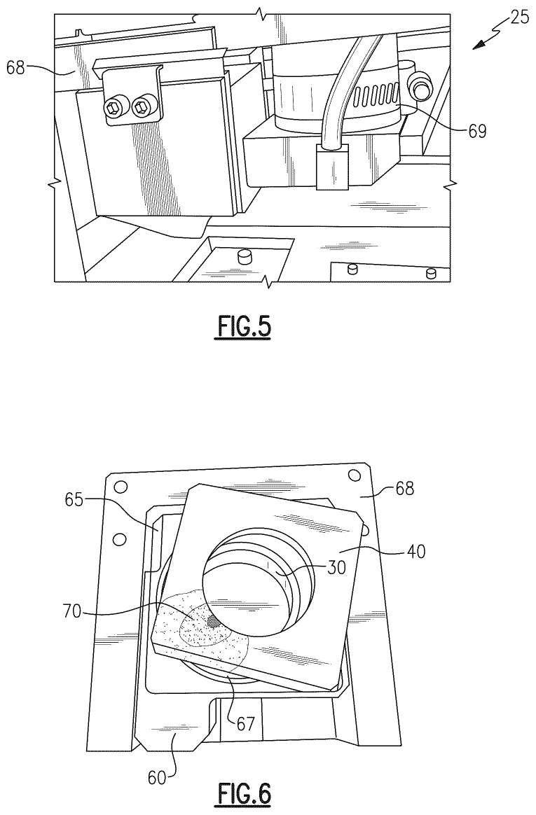

An example of the internal structure of the laser cutting machine 25 of FIG. 3 is shown in FIG. 5. Such a laser cutting machine is configured for use with the known lens plate 40 and lens plate holder 60 of FIG. 4, with the lens plate 40 and lens plate holder 60 being retained in a section 68 of the machine 25 (see FIG. 4, section 68). The laser L and lens plate holder 60 are configured such that, when the lens plate 40 rests on surface 65, the laser beam propagates through the protective lens 30. When positioned correctly on the lens plate holder 60, the lens plate 40 does not obstruct the path of the laser beam. However, when the position of the lens plate 40 changes due to fluctuations in vacuum pressure, the lens plate 40 can obstruct the path of the laser beam. This interrupts the cutting process. The result of such an obstruction is, therefore, errors in the formation of integrated circuit dies. The resulting wafer 10 must be scrapped or discarded. The laser cutting machine 25 further comprises other features to protect the amplifying lens from exhaust fumes. For example, an exhaust pipe 69.

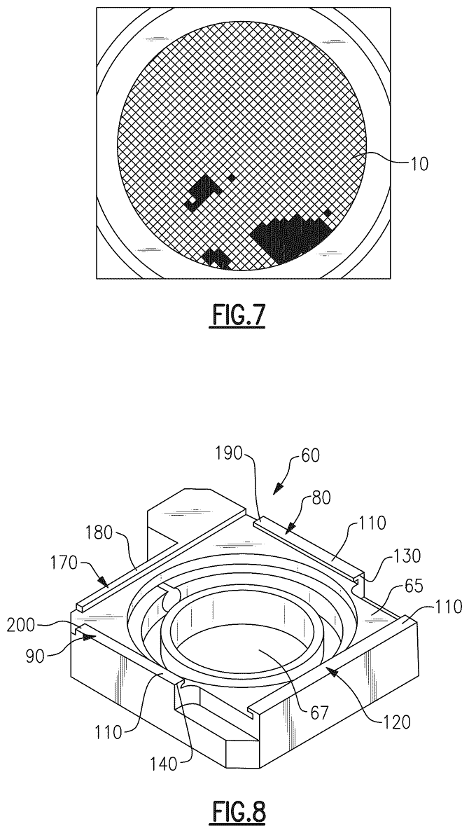

An example of a lens plate 40 that has obstructed a laser beam path is shown in FIG. 6. An area of charring 70 indicates where on the lens plate 40 the laser beam has made contact. FIG. 7 then shows an example wafer 10 that is the result of laser beam obstruction during the cutting process and which, therefore, needs to be scrapped.

The inventors of the lens plate holder described herein have appreciated that by using a lens plate holder comprising a plurality of engagement portions with which the lens plate can slidably engage, the lens plate can be fixed in place during the laser cutting process. Furthermore, such a lens plate holder ensures that the lens plate is always positioned correctly for the laser cutting process. In this way, the lens plate does not obstruct the laser beam during the cutting process. This decreases the number of wafers that need to scrapped, increasing die yield.

According to some aspects of the present disclosure, a lens plate holder for a semiconductor wafer laser cutting system is provided, the system having increased die yield.

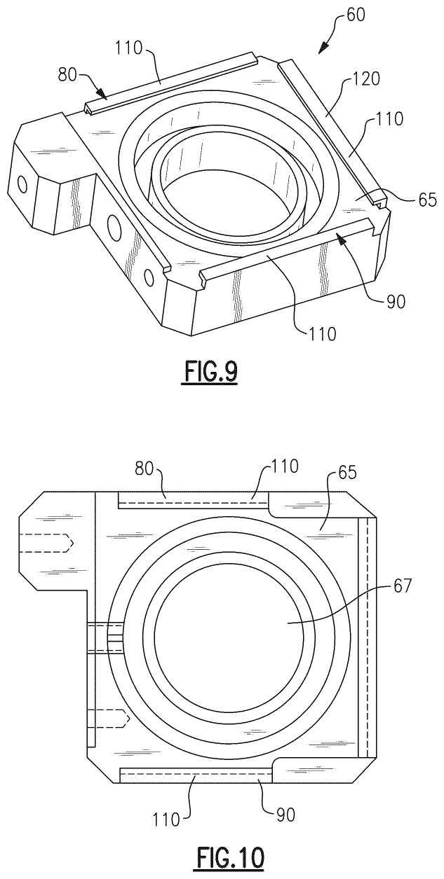

An example lens plate holder 60 according to aspects of the present disclosure is shown in FIGS. 8 and 9. The lens plate holder 60 shares features with the known lens plate holder 60 of FIGS. 4 and 6. Like features have been given like reference numerals. The configuration of the engagement portions and the fixing mechanism, however, is significant and is discussed in more detail below.

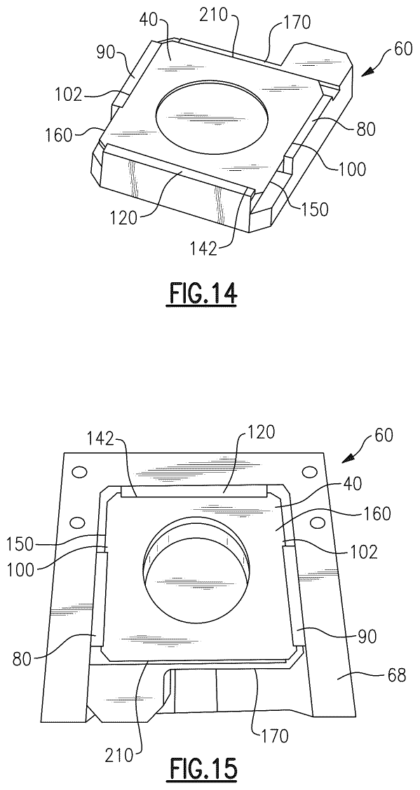

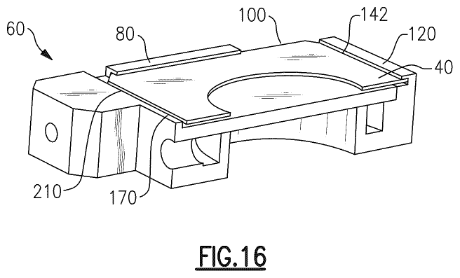

Lens plate holder 60 comprises at least two engagement portions 80, 90. The engagement portions 80, 90 are configured to hold a lens plate 40. An example of such a lens plate is the known lens plate 40 shown in FIGS. 4 and 6. The lens plate 40 can be held by the lens plate holder 60 by slidably engaging the lens plate 40 with the engagement portions 80, 90. In this example, there is a first engagement portion 80 and a second engagement portion 90. The first engagement portion 80 opposes the second engagement portion 90. In this way, the first engagement portion 80 and the second engagement portion 90 form a pair of opposing grooves into which the lens plate 40 can be slid. The first engagement portion 80 is configured to engage a first edge of the lens plate 40 (see FIGS. 14 and 15, first edge 100) and the second engagement portion 90 is configured to engage a second edge of the lens plate 40 (see FIGS. 14 and 15, second edge 102). The first edge 100 of the lens plate 40 opposes the second edge 102 of the lens plate 40. As a result, when engaged with the lens plate holder 60 as described, the lens plate 40 is restricted from moving beyond a boundary established by the first engagement portion 80 and a boundary established by the second engagement portion 90.

The first engagement portion 80 and the second engagement portion 90 project from the surface 65 configured to support the lens plate 40. The lens plate 40 is, therefore, supported by the surface 65 when held by the lens plate holder 60. Each engagement portion 80, 90 comprises a section 110 which overhangs surface 65. This contributes to the groove structure of the engagement portions 80, 90 which facilitates sliding the lens plate 40 into them. Furthermore, the overhanging structure helps fasten the lens plate 40 to surface 65 such that the lens plate 40 is further restricted from moving such that it no longer rests on surface 65. In other words, the overhanging structure of the engagement portions 80, 90 clamps the lens plate to surface 65.

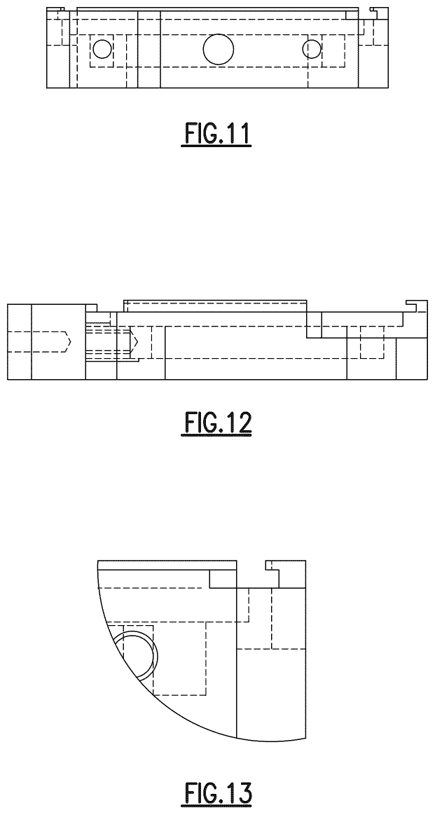

FIGS. 10 to 13 show the lens plate holder of FIG. 8 from different perspectives, giving an indication of the relative proportions of the features of the lens plate holder 60. Referring to FIG. 10, the first engagement portion 80 is configured to extend along a length of the first edge of the lens plate 40 (see FIGS. 14 and 15, first edge 100) and the second engagement portion 90 is configured to extend along a length of the second edge of the lens plate 40 (see FIGS. 14 and 15, second edge 102). The length of the first and second engagement portions 80, 90 is such that, when engaged with the lens plate 40, there is adequate contact between the lens plate 40 and the engagement portions 80, 90 to hold the lens plate 40 in place. The length of the first and second engagement portions 80, 90 is typically between 15 millimeters and 30 millimeters. Specifically, in this example, the length of the first and second engagement portions 80, 90 is 24 millimeters.

The first and second engagement portions 80, 90 are configured such that their height corresponds to a thickness of the lens plate 40. In other words, the height of the grooves in which the lens plate 40 is to be slid is chosen to be sufficiently larger than the thickness of the lens plate 40 such that the lens plate can fit into the grooves. However, the height of the grooves is also chosen to be sufficiently close to that of the lens plate 40 such that they fasten the lens plate 40 to the surface 65. The height of the first and second engagement portions 80, 90 is typically between 0.5 millimeters and 1.5 millimeters. Specifically, in this example, the height of the first and second engagement 80, 90 portions is 1 millimeter.

The first and second engagement portions 80, 90 are configured such that their width does not obstruct the opening 67. More specifically, the width of the overhanging sections 110 is chosen such that they do not cover the opening 67. This ensures the laser beam can propagate through the protective lens unobstructed. The width of the first and second engagement portions 80, 90 is typically between 1 millimeter and 3.5 millimeters. Specifically, in this example, the width of the first and second engagement portions 80, 90 is 2.3 millimeters.

Referring back to the example shown in FIG. 8, the lens plate holder 60 comprises a third engagement portion 120. The third engagement portion 120 shares similar features with the first and second engagement portions 80, 90. Like features have been given like reference numerals. Differences of significance are discussed in more detail below. Like the first and second engagement portions 80, 90, the third engagement portion 120 projects from surface 65 and comprises an overhanging section 110. In this way, the third engagement portion 120 forms a groove into which the lens plate 40 can be slid. Furthermore, like the first and second engagement portions 80, 90, the height of the third engagement portion 120 is configured to correspond to the thickness of the lens plate 40. Specifically, in this example, the height of the third engagement portion 120 is 1 millimeter. Again, like the first and second engagement portions 80, 90, the width of the third engagement portion 120 is chosen such that the overhanging portion 110 does not obstruct the opening 67 for the lens. Specifically, in this example, the width of the third engagement portion 120 is 2.8 millimeters.

The third engagement portion 120 is configured to hold a lens plate. An example of such a lens plate is the known lens plate 40 shown in FIGS. 4 and 6. The lens plate 40 can be held by slidably engaging the lens plate 40 with the third engagement portion 120. The third engagement portion 120 is positioned such that it is adjacent to a first end 130 of the first engagement portion 80 and a first end 140 of the second engagement portion 90. In this example, the first and second engagement portions 80, 90 form a pair of parallel grooves and the third engagement portion 120 is positioned such that the first, second, and third engagement portions 80, 90, 120 extend around the perimeter of a rectangular shape. The third engagement portion 120 is configured to engage a third edge of the lens plate 40 (see FIGS. 14 and 15, third edge 142). In this way, the third engagement portion 120 acts as a barrier or stopping mechanism restricting how far the lens plate 40 can be pushed into the lens plate holder 60. In other words, the third engagement portion 120 further restricts movement of the lens plate 40 when held by the lens plate holder 60.

Still referring to the example shown in FIG. 8, similarly to the first and second engagement portions 80, 90, the length of the third engagement portion 120 is configured to extend along a length of the third edge of the lens plate (see FIGS. 14 and 15, third edge 142). However, the length of the third engagement portion 120 is larger than the length of the first engagement portion 80 and the second engagement portion 90. This is to maximize the extent of the third engagement portion 120 along the third edge 142 of the lens plate 40. The shorter first and second engagement portions 80, 90, however, leave a section of the first edge of the lens plate and a section of the second edge of the lens plate exposed. This is shown in FIGS. 14 and 15, which depict an assembled lens plate 40 and lens plate holder 60. Sections 150 and 160 are uncovered by the engagement portions 80, 90. These sections 150, 160 of the lens plate 40 can then be used to facilitate manual handling of the lens plate 40. For example, when removing the lens plate 40 from the lens plate holder 60 or subsequently repositioning the lens plate 40 on the lens plate holder 60. Typically, the length of the third engagement portion 120 is between 30 millimeters and 45 millimeters. Specifically, in this example, the length of the third engagement portion 120 is 37 millimeters. In other examples, such as that shown in FIG. 9, the first and second engagement portions 80, 90 are the same length as the third engagement portion.

Referring again to the lens plate holder 60 of FIG. 8, the lens plate holder 60 comprises a fixing mechanism 170. The fixing mechanism 170 is configured to fix a lens plate in place when the lens plate is held by engagement portions 80, 90 and 120. To do this, the fixing mechanism 170 comprises a raised portion 180 which projects from surface 65. The raised portion 180 is positioned adjacent to a second end 190 of the first engagement portion 80 and a second end 200 of the second engagement portion 90. The raised portion 180 further opposes the third engagement portion 120. The raised portion 180 is configured to extend along a fourth edge of the lens plate (see FIGS. 14 and 15, fourth edge 210 of lens plate 40). In other words, the first, second and third engagement portions 80, 90, 120 and the fixing mechanism 170 extend along the perimeter of a rectangular shape. In this way, if a lens plate 40 is engaged with the first, second and third engagement portions 80, 90, 120, adjusting the positioning of the lens plate 40 such that the fixing mechanism 170 extends along the fourth edge 210 fixes the position of the lens plate 40. The fixing mechanism 170, therefore, forms a barrier at the fourth edge 210 of the lens plate 40. Said barrier prevents the lens plate 40 from sliding out of the engagement portions 80, 90, 120 of the lens plate holder 60.

Like the first, second, and third engagement portions 80, 90, 120, the length of the fixing mechanism 170 is configured such as to extend along the fourth edge 210 of the lens plate 40. Increasing the points of contact between the fourth edge 210 and the fixing mechanism 170 gives the lens plate 40 less room to move when fixed in the lens plate holder 60. Typically, the length of the fixing mechanism 170 is between 30 millimeters and 45 millimeters. Specifically, in this example, the length of the fixing mechanism 170 is 40 millimeters.

According to some aspects of the present invention, a method of assembling a semiconductor wafer laser cutting system is provided, the method leading to increased die yield.

FIGS. 14 and 15 show an assembled lens plate 40 and lens plate holder 60 for use in a laser cutter such as that shown in FIG. 3. The lens plate 40 and lens plate holder 60 are assembled by sliding the lens plate 40 into the engagement portions 80, 90, 120 of the lens plate holder. Surface 65 supports the lens plate 40 during this process. The lens plate 40 first slides into the first and second engagement portions 80, 90. This happens simultaneously. Furthermore, this is done by sliding the first edge 100 of the lens plate 40 along the first engagement portion 80 and the second edge 102 of the lens plate 40 along the second engagement portion 90. The lens plate 40 itself is configured to be flexible. This allows flexing of the lens plate 40, facilitating sliding it into the relevant engagement portions 80, 90, 120 and subsequently fixing it into position using the fixing mechanism 170. Once engaged with the first and second engagement portions 80, 90, the lens plate 40 and lens plate holder 60 are further assembled by pushing the lens plate 40 into the lens plate holder 60 up until the point that at which the third edge 142 of the lens plate 40 is engaged with the third engagement portion 120. In other words, until the third engagement portion 120 acts as a barrier preventing the lens plate 40 from being pushed any further. Once the first, second and third edges 100, 102, 142 of the lens plate 40 are engaged, respectively, with the first, second, and third engagement portions 80, 90, 120, the lens plate 40 and lens plate holder 60 are further assembled by adjusting or pushing the fourth edge 210 of the lens plate 40 such that it is positioned adjacent to the fixing mechanism 170 and is supported by surface 65. The fixing mechanism 170 forms a barrier preventing the lens plate 40 from sliding out of the engagement portions 80, 90, 120. In this way, the fixing mechanism 170 fixes the position of the lens plate 40 such that it remains engaged with the engagement portions 80, 90, 120 of the lens plate holder 60. The lens plate holder 60, as a result, is holding the lens plate 40, ready for use in a laser cutting process.

As shown in FIGS. 14, 15 and 16, when assembled, the lens plate 40 is resting on surface 65 such that it is supported by surface 65. The first, second, and third edges 100, 102, 142 of the lens plate 40 are, respectively, engaged with the first, second, and third engagement portions 80, 90, 120. Finally, the fourth edge 210 of the lens plate 40 is adjacent to the fixing mechanism 170.

According to some aspects of the present disclosure, a lens plate holder for a semiconductor wafer laser cutting system and method of assembling such a system is provided, the system and method producing increased die yield. As explained above, vacuum fluctuations in a laser cutting system can lead to the lens plate retaining the protective lens being displaced from its proper position on the lens plate holder. This can lead to the lens plate obstructing the laser beam, disrupting the cutting process and leading to wafers that need to be scrapped. The improved lens plate holder according to aspects of the present disclosure addresses this problem by using a plurality of engagement portions and a fixing mechanism to hold the lens plate in place. This ensures that the lens plate does not block the laser beam during the cutting process. As a result, the need to scrap wafers is eliminated, increasing die yield.

Furthermore, as protective lenses require frequent cleaning, and therefore removal and subsequent repositioning of the lens plate, there is ample opportunity for the lens plate to be repositioned incorrectly. This, too, can lead to the lens plate blocking the laser beam, requiring wafers to be scrapped. The improved lens plate holder according to aspects of the present disclosure addresses this problem using a poka-yoke solution. In other words, the solution eliminates the possibility of operator error. The engagement portions and fixing mechanisms together prevent the lens plate from being positioned incorrectly. This, again, eliminates the need to scrap wafers, increasing die yield.

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A lens plate holder for a semiconductor wafer laser cutter, the lens plate holder comprising a first engagement portion opposing a second engagement portion, the first engagement portion and the second engagement portion slidably engage a lens plate.

2. The lens plate holder of claim 1 further comprising a surface configured to support the lens plate and the first engagement portion and the second engagement portion project from the surface.

3. The lens plate holder of claim 2 wherein the surface has an opening corresponding to a shape of a protective lens.

4. The lens plate holder of claim 1 wherein the first engagement portion engages a first edge of the lens plate and the second engagement portion engages a second edge of the lens plate.

5. The lens plate holder of claim 1 further comprising a third engagement portion.

6. The lens plate holder of claim 5 wherein the third engagement portion is positioned adjacent to a first end of the first engagement portion and a first end of the second engagement portion.

7. The lens plate holder of claim 6 wherein the third engagement portion slidably engages the lens plate.

8. The lens plate holder of claim 6 wherein the third engagement portion engages a third edge of the lens plate.

9. The lens plate holder of claim 6 wherein a length of the first engagement portion extends along a portion of a first edge of the lens plate, a length of the second engagement portion extends along a portion of a second edge of the lens plate, and a length of the third engagement portion extends along a portion of a third edge of the lens plate.

10. The lens plate holder of claim 6 further comprising a fixing mechanism that positions a first edge of the lens plate in the first engagement portion, a second edge of the lens plate in the second engagement portion and a third edge of the lens plate in the third engagement portion.

11. The lens plate holder of claim 10 wherein the fixing mechanism has a raised portion projecting from a surface that supports the lens plate.

12. The lens plate holder of claim 10 wherein the fixing mechanism is positioned adjacent to a second end of the first engagement portion and a second end of the second engagement portion.

13. A semiconductor wafer laser cutting system, comprising:
a laser that emits a laser beam;
an amplifying lens that amplifies the laser beam to cut a semiconductor wafer;
a lens plate that retains a protective lens that protects the amplifying lens; and
a lens plate holder having a first engagement portion opposing a second engagement portion, the first engagement portion and the second engagement portion slidably engage the lens plate.

14. The system of claim 13 wherein the lens plate is flexible.

15. The system of claim 13 wherein the protective lens protects the amplifying lens from fumes produced by cutting the semiconductor wafer.

16. The system of claim 13 wherein the lens plate holder holds the lens plate in such a position that the lens plate does not obstruct a path of the laser beam.

17. A method of assembling a semiconductor wafer laser cutting system, comprising:
slidably engaging a lens plate with a first engagement portion and a second engagement portion of a lens plate holder, the first engagement portion opposing the second engagement portion; and
holding the lens plate by way of the first engagement portion and the second engagement portion.

18. The method of claim 17 further comprising slidably engaging the lens plate with a third engagement portion of the lens plate holder, the third engagement portion positioned adjacent to a first end of the first engagement portion and a first end of the second engagement portion.

19. The method of claim 18 further comprising fixing the lens plate into a position by engaging a first edge with the first engagement portion, engaging a second edge of the lens plate with the second engagement portion and engaging a third edge of the lens plate with the third engagement portion.

20. The method of claim 19 wherein fixing the lens plate includes positioning a fourth edge of the lens plate adjacent to a fixing mechanism of the lens plate holder, the fixing mechanism opposing the third engagement portion.
